(19) United States
(12) Patent Application Publication
(10) Pub. No.: US 2025/0219157 A1
(43) Pub. Date: Jul. 3, 2025

(54) METHYLENE METHANEDISULFONATE AS AN ELECTROLYTE ADDITIVE FOR LITHIUM-MANGANESE RICH ELECTRODES

(71) Applicant: FORD GLOBAL TECHNOLOGIES, LLC, Dearborn, MI (US)

(72) Inventors: Liyuan SUN, Ann Arbor, MI (US); Eunsung LEE, Novi, MI (US); Keonseok OH, Dearborn, MI (US); Sangil HAN, Dearborn, MI (US); Gunho KWAK, Novi, MI (US); Chi PAIK, Grosse Ile, MI (US)

(21) Appl. No.: 18/398,812

(22) Filed: Dec. 28, 2023

(51) Int. Cl. H01M 10/42; H01M 10/0567

(52) U.S. Cl. CPC H01M 10/4235; H01M 10/0567

(57) ABSTRACT

A battery cell comprising a negative electrode, a lithium-manganese rich positive electrode, and an electrolyte with a methylene methanedisulfonate additive is presented. The electrolyte with the methylene methanedisulfonate additive saturates the negative and lithium-manganese rich positive electrodes such that during cycling of the battery, a positive electrolyte interface forms on a surface of the lithium-manganese rich positive electrode. The positive electrolyte interface results in a direct current impedance of the battery cell, for a given state of charge, being less than a direct current impedance of an otherwise same battery cell without the methylene methanedisulfonate additive.

### TECHNICAL FIELD

This disclosure relates to electrolyte additives used in lithium-ion batteries.

### BACKGROUND

Lithium-manganese rich (LMR) cathodes have a higher specific capacity and gravimetric energy density compared to other lithium-ion battery cathode materials such as lithium iron phosphate (LFP) and lithium nickel manganese cobalt oxide (NCM). However, a lithium-ion battery with an LMR cathode may show diminished capacity retention over successive cycles which may be caused by interaction between the LMR cathode and an electrolyte.

### SUMMARY

A battery cell comprising a negative electrode, a lithium-manganese rich positive electrode, and an electrolyte is disclosed. This electrolyte includes a methylene methanedisulfonate additive, and saturates both the negative and lithium-manganese rich positive electrodes. The cycling of the battery cell, at an upper cut-off voltage of 4.45 volts, leads to the formation of a positive electrolyte interface on the surface of the lithium-manganese rich positive electrode. This interface reduces the direct current impedance of the battery cell for a given state of charge, as compared to a similar battery cell without the additive. The positive electrolyte interface contributes to a capacity retention of the battery cell at 45 degrees Celsius and after 100 cycles of charge and discharge being greater than a capacity retention of a comparable battery cell lacking the methylene methanedisulfonate additive. Additionally, the electrolyte saturates the negative electrode as previously mentioned, resulting in the formation of a solid electrolyte interface on a surface of the negative electrode, which faces the positive electrolyte interface.

The methylene methanedisulfonate additive's weight percentage in the electrolyte ranges from 0.1 wt % to 5 wt %. The electrolyte itself comprises the methylene methanedisulfonate additive, a lithium salt, and a solvent, wherein the lithium salt may be lithium hexafluorophosphate. The solvent used in this electrolyte may be a carbonate-based solvent. The lithium-manganese rich positive electrode in the battery cell includes a metal current collector and a lithium-manganese rich active material layer on the metal current collector. The negative electrode may be graphite-based. Additionally, the battery cell may incorporate a separator, which is also saturated by the electrolyte.

An electrode assembly comprising a current collector and a lithium-manganese rich active material layer on the current collector is presented. The electrolyte includes methylene methanedisulfonate additive and saturates the lithium-manganese rich active material layer. During cycling of the electrode, a solid electrolyte interface forms on the surface of the lithium-manganese rich active material layer. The weight percentage of the methylene methanedisulfonate additive in the electrolyte is between 0.1 wt % to 5 wt %. The electrode assembly may further include a separator saturated by the electrolyte.

Another battery cell, comprising a negative electrode, a lithium-manganese rich positive electrode, and an electrolyte is presented. The electrolyte includes a methylene methanedisulfonate additive, and saturates both the negative and lithium-manganese rich positive electrodes. During cycling of the battery, the formation of a positive electrolyte interface occurs on a surface of the lithium-manganese rich positive electrode. This interface contributes to a capacity retention of the battery cell better than that of a similar battery cell without the methylene methanedisulfonate additive. The positive electrolyte interface also contributes to a reduction in the direct current impedance of the battery cell, for a given state of charge when compared to a similar battery cell without the additive.

The weight percentage of the methylene methanedisulfonate additive in the electrolyte is between 0.1 wt % to 5 wt %. The electrolyte may be made by dissolving a lithium salt in a solvent and adding the methylene methanedisulfonate additive. The lithium salt used may be lithium hexafluorophosphate, and the solvent may be carbonate-based. The lithium-manganese rich positive electrode of the battery cell includes a metal current collector with a lithium-manganese rich active material layer on it. The negative electrode of the battery cell may be made of a graphite-based material. The battery cell may include a separator also saturated by the electrolyte.

### BRIEF DESCRIPTION OF THE DRAWINGS

FIGS. 1A-1E are graphs showing battery cell cycle life performance for different electrolyte additives and methylene methanedisulfonate;

FIGS. 2A and 2B are graphs showing charge and discharge direct current internal resistance for methylene methanedisulfonate;

FIGS. 3A and 3B are graphs showing the growth of charge and discharge direct current internal resistance for methylene methanedisulfonate;

FIG. 4 is a schematic illustration of a battery cell according to one embodiment; and

FIG. 5 is a schematic illustration of a battery electrode according to one embodiment.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A technical challenge with lithium-manganese rich (LMR) cathode-based lithium-ion batteries (LiBs) is that they may show diminished capacity retention over time. This may be caused by the interaction between the LMR cathode and a cathode electrolyte interface at voltages above 4.40V. Experimental investigations into electrolyte additives that perform well in the necessary high-voltage (HV) conditions have yielded mixed results. Electrolyte additives that are known to perform well with cathode materials in LiBs, such as lithium cobalt oxide (LCO), lithium ion manganese oxide battery (LMO), lithium iron phosphate (LFP) and lithium nickel manganese cobalt oxide (NCM), generally do not perform similarly when paired with a LiB that has a LMR cathode. Such additives include ethylene sulfate (ESA), 1,3-propanediol cyclic sulfate (PCS), lithium bis(oxalate) borate (LiBOB), and 1,3,6-hexanetricarbonitrile (HTN). 1.9 Ah pouch cell samples with the LMR cathodes and the respective electrolyte additives were prepared. The experimental results for capacity retention over cycles at an upper control voltage (UCV) of 4.45V for the respective additives in an electrolyte of a battery cell with an LMR-based cathode have been documented. For comparison purposes, the same baseline lithium salt electrolyte was utilized across all samples. Additionally, each additive was incorporated into this lithium salt electrolyte.

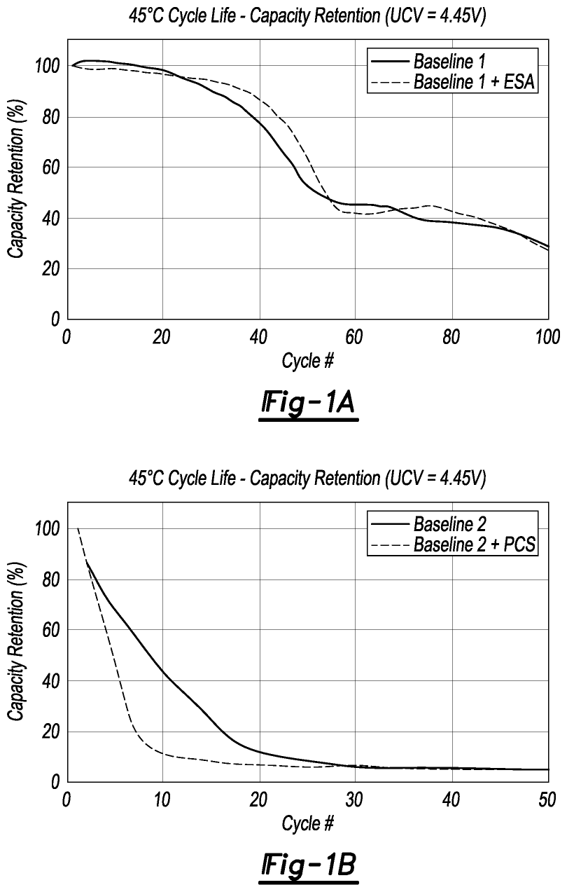

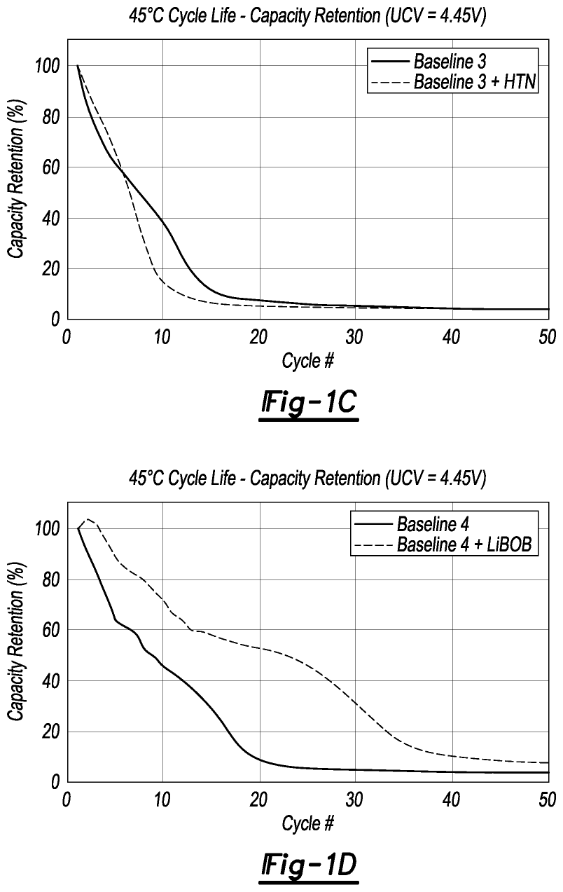

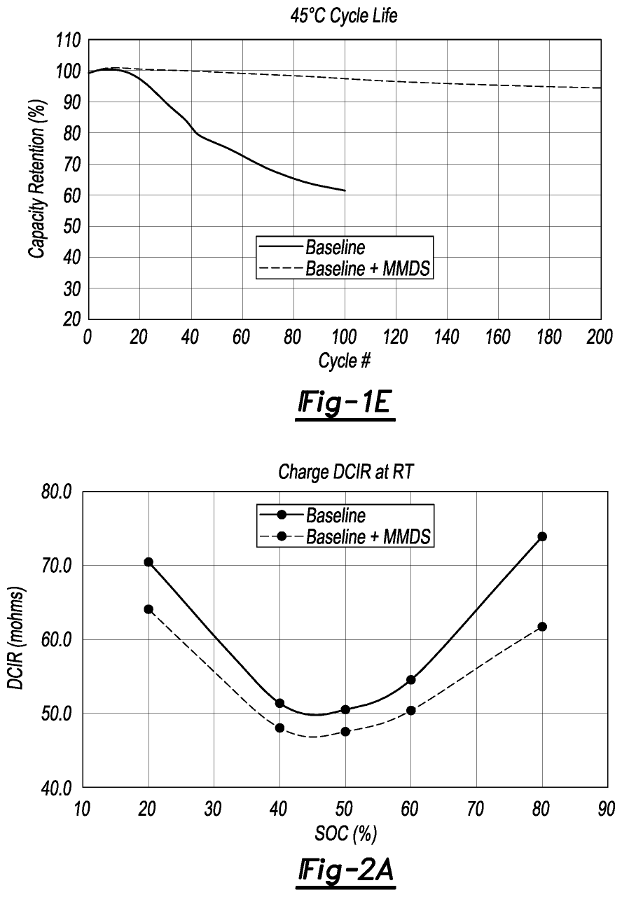

Referring now to the figures, FIG. 1A. shows the effect of 3.0 wt % ESA electrolyte additive on cell capacity retention at an UCV of 4.45V and an elevated temperature of 45° C. over consecutive cycles compared to the baseline electrolyte without additive. It can be observed that there is negligible difference in capacity retention between the baseline electrolyte without additive and the electrolyte with ESA additive. FIG. 1B. shows the effect of 3.0 wt % PCS electrolyte additive on cell cycle capacity retention at an UCV of 4.45V and an elevated temperature of 45° C. over consecutive cycles compared to the baseline electrolyte without additive. It can be observed that the electrolyte additive with PCS performs worse than the baseline. FIG. 1C. shows the effect of 3.0 wt % HTN electrolyte additive on cell capacity retention at an UCV of 4.45V and an elevated temperature of 45° C. over consecutive cycles compared to the baseline electrolyte without additive. It can be observed that there is a negligible difference between the capacity retention for the two electrolytes. FIG. 1D. shows the effect of 3.0 wt % LiBOB additive on cell capacity retention at an UCV of 4.45V and an elevated temperature of 45° C. over consecutive cycles compared to the baseline electrolyte without additive. It can be observed that the electrolyte additive with LiBOB showed initial higher capacity retention than the baseline electrolyte. However, the capacity retention of the electrolyte with LiBOB is negligibly better than the baseline electrolyte after 30 cycles.

Methylene methanedisulfonate (MMDS) was also evaluated as a bi-functional additive to form a stable and ionic conductive solid electrolyte interface (SEI) on an anode and a cathode electrolyte interface (CEI) on an LMR cathode. A 1.9 Ah pouch cell was prepared with an electrolyte having 3.0 wt % of MMDS additive. It was unexpectedly observed that the LMR cathode-based LiB with 3.0 wt % MMDS additive in the electrolyte showed reduced cell impedance at beginning of life, had greater capacity retention over cycles at HV and elevated temperatures, and had reduced cell impedance growth over cycles at HV and elevated temperatures. FIG. 1E. shows the effect of MMDS electrolyte additive on cell capacity retention at an UCV of 4.45V and elevated temperature of 45° C. over consecutive cycles compared to the baseline electrolyte without additive. It can be seen that the electrolyte with MMDS has greater capacity retention compared to the baseline electrolyte over all of the cycles for which data is available.

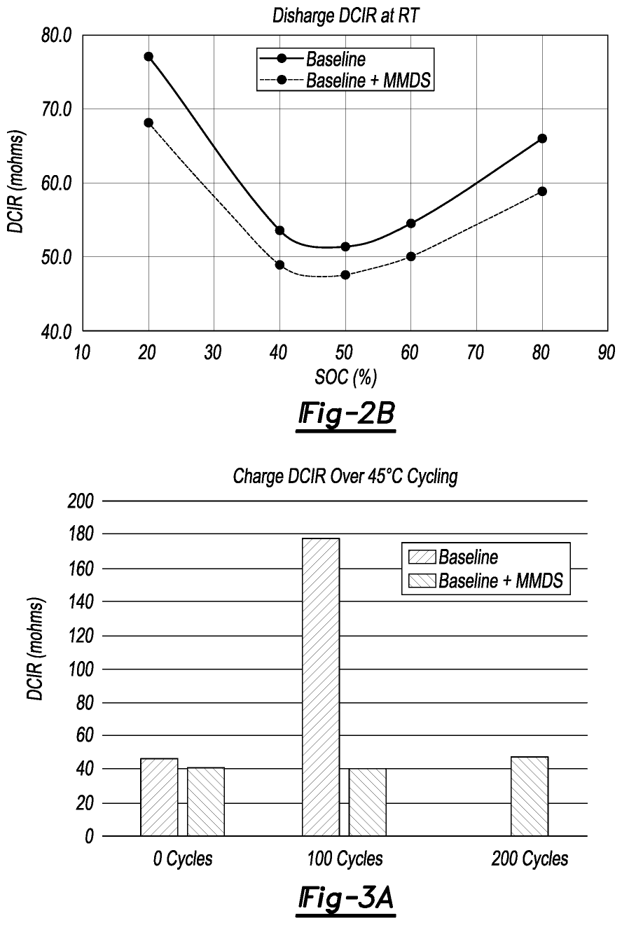

FIG. 2A shows the effect of MMDS electrolyte additive on cell charge direct current internal resistance (DCIR) at room temperature (RT) compared to the baseline electrolyte. From the graph it can be observed that cells with the MMDS electrolyte additive exhibit a lower DCIR during the charging phase, indicating improved charge efficiency compared to the baseline electrolyte. FIG. 2B shows the effect of MMDS electrolyte additive on cell discharge DCIR at RT. The graph shows that the MMDS additive also reduces the DCIR in the discharge phase compared to the baseline electrolyte, further suggesting increased discharge efficiency relative to the baseline electrolyte. FIG. 3A shows the growth of charge DCIR over time in an electrolyte with MMDS additive compared to the baseline electrolyte. It can be observed that there is a slower increase in charge DCIR for cells with MMDS additive compared to the baseline electrolyte, indicative of improved charge stability relative to the baseline. FIG. 3B shows the growth of discharge DCIR in an electrolyte with MMDS additive compared to the baseline electrolyte. The graph shows a more gradual increase in discharge DCIR for the electrolyte with MMDS additive compared to the baseline electrolyte, indicative of sustained discharge performance over consecutive cycles.

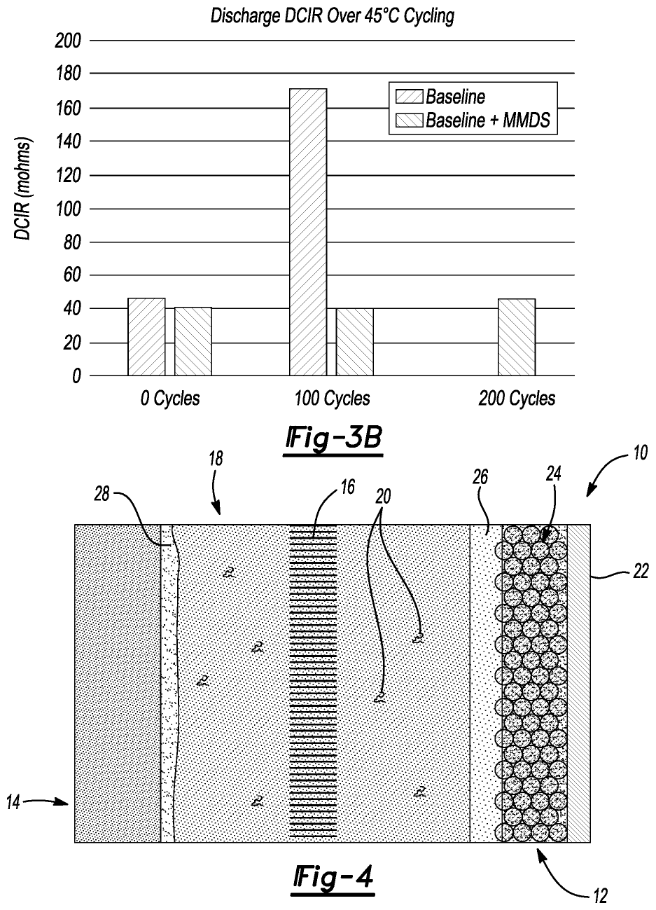

FIG. 4 illustrates a schematic view of a battery cell 10, according to one aspect of the disclosure. The battery cell 10 has a positive electrode 12, a negative electrode 14, and a separator 16 saturated by an electrolyte 18 with a methylene methanedisulfonate (MMDS) additive 20. The positive electrode 12 comprises a current collector 22, which may be a metal current collector 22, and a lithium-manganese rich (LMR) active material layer 24 on the current collector 22. The negative electrode 14 may be made of a graphite-based material. The electrolyte 18 saturating the positive electrode 12, negative electrode 14, and separator 16 may be formed by dissolving a lithium salt into a solvent and adding 0.1 to 5.0% wt % of MMDS additive 20. The solvent used for this may be any suitable carbonate-based solvent. The solvent may also be a mixture of linear and cyclic carbonate-based solvents. The lithium salt dissolved into the solvent may be any suitable lithium salt such as hexafluorophosphate.

During cycling of the battery cell 10, at an upper cut-off voltage of 4.45 volts, the MMDS additive 20 in the electrolyte 18 facilitates the formation of a positive electrolyte interface 26 on a surface of the LMR active material layer 24. The positive electrolyte interface 26 contributes to the resulting battery cell 10 having a lower direct current impedance for a given state of charge compared to a similar battery cell without the MMDS additive 20. The positive electrolyte interface 26 further results in a capacity retention of the battery cell 10, at 45 degrees C. temperature after 100 cycles of charge and discharge, being greater than a capacity retention of an otherwise same battery cell without the MMDS additive 20. Additionally, the MMDS additive 20 in the electrolyte 18 may also contribute to the formation of a solid electrolyte interface 28 on a surface of the negative electrode 14 facing the positive electrolyte interface 26. This may also contribute to the overall electrochemical stability and performance of the battery cell 10.

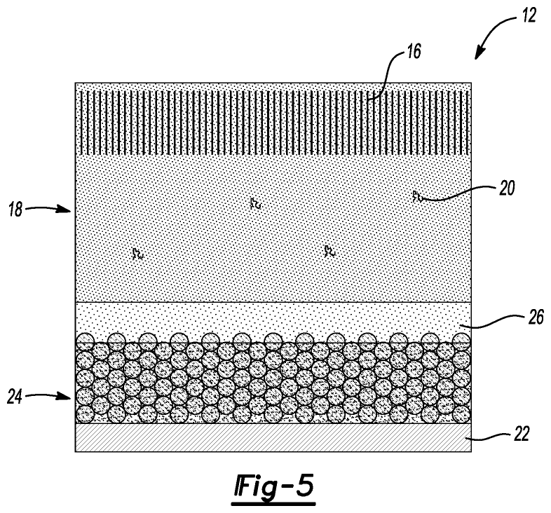

FIG. 5 illustrates a schematic view of the battery electrode 12, according to one aspect of the disclosure. The positive electrode 12 includes the current collector 22 and the LMR active material layer 24 deposited on the current collector 22. The electrolyte 18, with the MMDS additive 20, saturates the LMR active layer 24 on the current collector 22. This saturation facilitates the formation of the positive electrolyte interface 26 on the surface of the LMR active material layer 24. The positive electrolyte interface 26 leads to a lower direct current impedance in the battery cell 10 at a given state of charge and improves the capacity retention at a temperature of 45 degrees Celsius after 100 charge and discharge cycles, compared to a battery cell without the MMDS additive 20. The weight percentage of MMDS additive 20 in the electrolyte 18 may be between 0.1 and 5.0%.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A battery cell comprising:
a negative electrode;
a lithium-manganese rich positive electrode; and
an electrolyte, including a methylene methanedisulfonate additive, saturating the negative and lithium-manganese rich positive electrodes such that during cycling of the battery, a positive electrolyte interface forms on a surface of the lithium-manganese rich positive electrode resulting in a direct current impedance of the battery cell, for a given state of charge, being less than a direct current impedance of an otherwise same battery cell without the methylene methanedisulfonate additive.

2. The battery cell of claim 1 wherein formation of the positive electrolyte interface further results in a capacity retention of the battery cell, at 45 degrees C. temperature and 100 cycles, being greater than a capacity retention of the otherwise same battery cell.

3. The battery cell of claim 1 wherein the electrolyte further saturates the negative electrode such that during the cycling, a solid electrolyte interface forms on a surface of the negative electrode facing the positive electrolyte interface.

4. The battery cell of claim 1 wherein a weight percentage of the methylene methanedisulfonate additive present in the electrolyte is between 0.1 wt % to 5 wt %.

5. The battery cell of claim 1 wherein the electrolyte including the methylene methanedisulfonate comprises a lithium salt and methylene methanedisulfonate dissolved into a solvent.

6. The battery cell of claim 5 wherein the lithium salt is lithium hexafluorophosphate.

7. The battery cell of claim 6 wherein the solvent is carbonate-based.

8. The battery cell of claim 1 wherein the lithium-manganese rich positive electrode includes a metal current collector and a lithium-manganese rich active material layer on the metal current collector.

9. The battery cell of claim 1 wherein the negative electrode is graphite-based.

10. The battery cell of claim 1, further including a separator saturated by the electrolyte.

11. An electrode assembly comprising:
a current collector;
a lithium-manganese rich active material layer on the current collector; and
an electrolyte including a methylene methanedisulfonate additive saturating the lithium-manganese rich active material layer.

12. The electrode assembly of claim 11 wherein the electrolyte saturates the lithium-manganese rich active material layer on the current collector such that during cycling of the electrode, a solid electrolyte interface forms on a surface of the lithium-manganese rich active material layer.

13. The electrode assembly of claim 11 wherein a weight percentage of the methylene methanedisulfonate additive present in the electrolyte is between 0.1 wt % to 5 wt %.

14. The electrode assembly of claim 11 further including a separator saturated by the electrolyte.

15. A battery cell comprising:
a negative electrode;
a lithium-manganese rich positive electrode; and
an electrolyte, including a methylene methanedisulfonate additive, saturating the negative and lithium-manganese rich positive electrodes such that during cycling of the battery, a positive electrolyte interface forms on a surface of the lithium-manganese rich positive electrode resulting in a capacity retention of the battery cell being less than a capacity retention of an otherwise same battery cell without the methylene methanedisulfonate additive.

16. The battery cell of claim 15 wherein formation of the positive electrolyte interface further results in a direct current impedance of the battery cell, for a given state of charge, being less than a direct current impedance of an otherwise same battery cell.

17. The battery cell of claim 15 wherein the negative electrode is graphite-based.

18. The battery cell of claim 15 wherein a weight percentage of the methylene methanedisulfonate additive present in the electrolyte is between 0.1 wt % to 5 wt %.

19. The battery cell of claim 15 wherein the electrolyte including the methylene methanedisulfonate comprises a lithium salt and methylene methanedisulfonate dissolved into a solvent.

20. The battery cell of claim 19 wherein the lithium salt is lithium hexafluorophosphate.
